(19) United States
(12) Patent Application Publication
(10) Pub. No.: US 2003/0095730 A1
(43) Pub. Date: May 22, 2003

(54) Optimal stiffness matching structure of planar bearing and axis of rotary mechanism

(76) Inventor: Richard Lee, Taipei (TW)

Correspondence Address: RICHARD LEE, P.O. BOX 26-757, TAIPEI, 106, TW

(21) Appl. No.: 10/002,369

(22) Filed: Nov. 21, 2001

(51) Int. Cl. F16C 33/02

(52) U.S. Cl. 384/276

(57) ABSTRACT

An optimal stiffness matching structure of planar bearing and axis of a rotary mechanism comprises a planar bearing and an axis. Mechanical characteristics of different materials are made use of to match the planar bearing and the axis. The planar bearing is made of one of metal alloy and ceramic, while the axis is made of the other one of metal alloy and ceramic. Mechanical characteristics of different materials are matched to effectively eliminate surface scratches on the slide face caused by intrusion of minute particles. Moreover, the planar bearing and the axis of different stiffness are matched to have second polishing function, letting the surface of the slide face having smaller stiffness have a roughness inversely proportional to time. Therefore, the time of operation of the slide face is effectively lengthened, the time of operation is greatly increased, and high-frequency noise owing to roughness is much reduced.

### FIELD OF THE INVENTION

The present invention relates to an optimal stiffness matching structure of planar bearing and axis of a rotary mechanism and, more particularly, to an optimal stiffness matching structure of planar bearing and axis of a rotary mechanism, which utilizes materials to change mechanical capacity so as to greatly increase lifetime of operation and decrease high-frequency noise owing to roughness.

### BACKGROUND OF THE INVENTION

An axis is an indispensable necessity in a rotary mechanism of any machinery. Although there are various kinds of different axes, they have the common point that the centers thereof are used for rotation. The component for supporting an axis is termed as a bearing. In addition to supporting an axis, a bearing also needs to let the axis rotate smoothly. Among all kinds of bearing, planar bearings are commonly used.

The planar bearing and axis of a conventional rotary mechanism are generally made of metallic materials. When minute particles (e.g., silicon dioxide, SiO₂) intrude into the slide face, surface scratches are caused to increase roughness of the slide face, hence greatly shortening lifetime of operation of the slide face. Moreover, high-frequency noise will be generated because of increase of roughness of the slide face.

Accordingly, the above planar bearing and axis of a conventional rotary mechanism have inconvenience and drawbacks in practical use. The present invention aims to resolve the problems in the prior art.

### SUMMARY OF THE INVENTION

The primary object of the present invention is to provide an optimal stiffness matching structure of planar bearing and axis of a rotary mechanism, which matches mechanical characteristics (e.g., stiffness) of different materials to effectively eliminate surface scratches on the slide face caused by intrusion of minute particles. Moreover, the planar bearing and axis of different stiffness are matched to have second polishing function so as to let the surface of the slide face having smaller stiffness have a roughness inversely proportional to time. In other words, the longer the time of operation, the smaller roughness of surface. Therefore, the time of operation of the slide face is effectively lengthened, hence greatly increasing the time of operation and decreasing high-frequency noise owing to roughness.

To achieve the above object, the present invention provides an optimal stiffness matching structure of planar bearing and axis of a rotary mechanism, which comprises a planar bearing and an axis. The planar bearing and axis are matched with different materials. The planar bearing is made of one of metal alloy and ceramic. The axis is made of the other one of metal alloy and ceramic. An optimal stiffness matching structure of planar bearing and axis of a rotary mechanism is thus formed.

The various objects and advantages of the present invention will be more readily understood from the following detailed description when read in conjunction with the appended drawing, in which:

### BRIEF DESCRIPTION OF THE DRAWINGS

FIG. 1 is a plan view of the present invention;

FIG. 2 is a photograph showing surface roughness of the present invention before operation; and

FIG. 3 is a photograph showing surface roughness of the present invention after operation for seventy days.

### DETAILED DESCRIPTION OF THE PREFERRED EMBODIMENTS

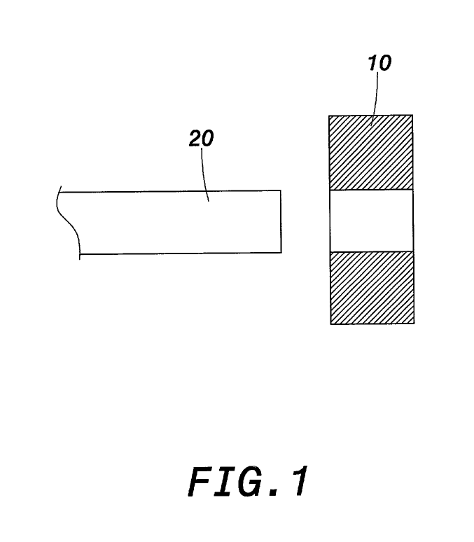

Referring to FIG. 1, the present invention provides an optimal stiffness matching structure of planar bearing and axis of a rotary mechanism, which comprises a planar bearing 10 and an axis 20. The planar bearing 10 is a hollow cylinder. The axis 20 is a cylinder. The inner diameter, outer diameter, and length of the planar bearing are determined to match the axis 20.

Mechanical characteristics (e.g., stiffness, compliance, etc.) of different materials are made use of to match the planar bearing 10 and the axis 20. The planar bearing 10 is made of one of metal alloy and ceramic, while the axis 20 is made of the other one of metal alloy and ceramic. In other words, if the planar bearing 10 is made of metal alloy, the axis 20 is made of ceramic; or if the planar bearing 10 is made of ceramic, the axis 20 is made of metal alloy.

Ceramic means oxide, carbide, or nitride with a stiffness (HRC) of about 90 degrees. Metal alloy is formed by mixing different metals or coating different metals on a substrate surface (e.g., electroplating, evaporation, sputtering, etc.) and then hardening them (e.g., heating, deep cooling, or permeating with nitrogen or carbon). The stiffness (HRC) of metal alloy is about 50˜60 degrees. An optimal stiffness matching structure of planar bearing and axis of a rotary mechanism of the present invention is thus formed.

In the present invention, mechanical characteristics (e.g., stiffness) of different materials are made use of to match the planar bearing and the axis of a rotary mechanism so as to effectively eliminate surface scratches on the slide face caused by intrusion of minute particles. Moreover, the planar bearing and the axis of different stiffness are matched to have second polishing function so as to let the surface having smaller stiffness of the slide face have a roughness inversely proportional to time. In other words, the longer the time of operation, the smaller roughness of surface. Therefore, the time of operation of the slide face is effectively lengthened, hence greatly increasing the time of operation and decreasing high-frequency noise owing to roughness.

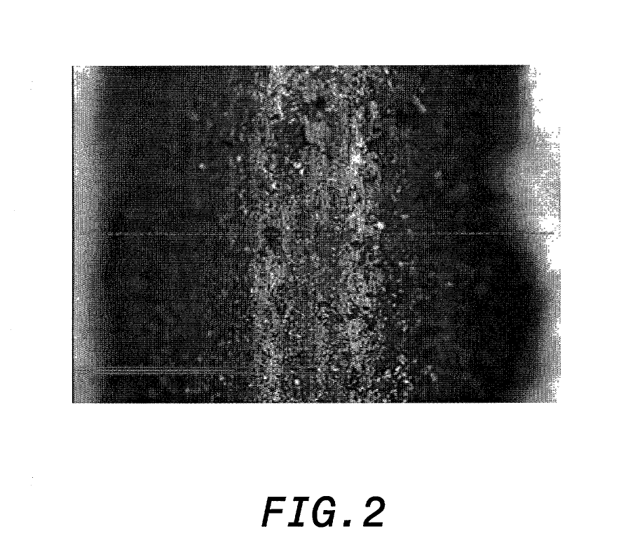

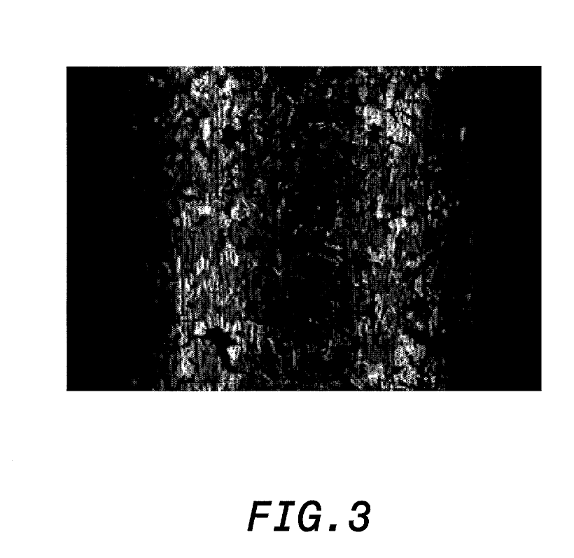

FIGS. 2 and 3 are photographs showing surface stiffness of the present invention before operation and after operation for seventy days, respectively. Evidently, the longer the time of operation, the smaller roughness of surface.

Additionally, in the present invention, four samples of planar bearings are tested. The sizes before operation are all within the range of tolerance (2.000±0.002 mm). The measured magnitudes of inner diameters of the planar bearings after operation are summarized in the following table.

TABLE 1

| Product Serial Number | Size in X axis | Size in Y axis |
|---|---|---|
| 168 | 2 | 1.998 |
| 177 | 2 | 1.998 |
| 97 | 2 | 2.002 |
| 154 | 1.999 | 2.001 |

As can be seen from the table, the variance of size before and after operation is very small.

Besides, Chung-Shan Institute of Science and Technology of R.O.C. is commended to perform Mean Time Between Failure (MTBF) test of the samples of the present invention. The results show that the lifetime of operation can be as large as 45.17 years or 396,000 hours. The estimated Failure Per Billion Device Hours within 1 billion hours of operation is 2,525. Evidently, the present invention can greatly increase the lifetime of operation.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An optimal stiffness matching structure of planar bearing and axis of a rotary mechanism comprising a planar bearing and an axis, said planar bearing and said axis being matched with different materials, said planar bearing being made of one of metal alloy and ceramic, said axis being made of the other one of metal alloy and ceramic.

2. The optimal stiffness matching structure of planar bearing and axis of a rotary mechanism as claimed in claim 1, wherein the ceramic means oxide, carbide, or nitride.

3. The optimal stiffness matching structure of planar bearing and axis of a rotary mechanism as claimed in claim 1, wherein the metal alloy is formed by mixing different metals or coating different metals on a substrate surface and then hardening them.
